(19) United States
(12) Patent Application Publication
(10) Pub. No.: US 2018/0224001 A1
(43) Pub. Date: Aug. 9, 2018

(54) Valve Assembly With Anti-Seizing

(71) Applicant: BORGWARNER INC., Auburn Hills, MI (US)

(72) Inventor: Petr Malik, Rochester Hills, MI (US)

(21) Appl. No.: 15/426,357

(22) Filed: Feb. 7, 2017

(51) Int. Cl. F16K 1/226

(52) U.S. Cl. CPC F16K 1/226

(57) ABSTRACT

A valve assembly includes a valve housing with a bore, a rotatable valve shaft coupled to the valve housing, a valve plate rotatable with the rotatable shaft, the valve plate being in a valve closed position at an angle greater or less than zero degrees, the valve plate including a first surface facing an inlet, a second surface facing an outlet, a first circumferential surface between the first surface and the second surface, and a second circumferential surface extending from at least one of the first surface or the second surface in a direction toward a reference axis and terminating at the first circumferential surface, the valve plate being in the valve closed position, the second circumferential surface defines a gap between the surface of the bore for avoiding contact with the surface of the bore, and the first circumferential surface and the second circumferential surface define a surface spaced therebetween to make contact with the surface of the bore that inhibits seizing of the valve plate with the surface of the bore when the valve plate is rotated by the rotatable shaft.

### BACKGROUND OF INVENTION

### 1. Field of Invention

The present invention relates generally to valve assemblies and, more specifically, to a valve assembly having a valve plate with a feature that may inhibit undesirable seizing that may occur during the operation of the valve plate.

### 2. Description of the Related Art

A variety of valves may be used for controlling functions of an internal combustion engine. These functions may include intake air control and exhaust gas flow control. A throttle type valve assembly having a rotatable valve plate within a bore is a typical valve that may be used for controlling these functions. Valve design and operating conditions may cause the valve plate to seize in the bore of the valve assembly especially when the valve plate is in a valve closed position and blocking fluid flow. The seizing of the valve plate in the bore may also be described as sticking or binding. Opening the throttle valve may require a force that may exceed the available force.

Seizing of the valve plate within the bore may result from contact between a surface or edge of the valve plate and a surface of the bore, and may be caused by friction, scrapping, gouging, or other condition. The potential for seizing may be increased under certain conditions. A first condition may occur when there is a build-up of residue or debris on the surface of the bore that may be deposited from a fluid such as exhaust gas or air flowing through the bore. A second condition may occur when a high closing force is applied by an actuator of the valve assembly or if a high external force, such as high fluid pressure, is applied to the valve plate. Under extreme conditions, the valve plate may flex and may increase the potential for seizing. Some actuators do not have sufficient available torque to overcome this condition. It is, therefore, desirable to develop a valve plate that will inhibit the seizing condition.

It is known that some valve plates may have an angle or arcuate surface to form sharp edges on circumferential and upper plate surfaces. This is undesired because seizing may still occur. Thus, there is a need in the art to provide a valve assembly having a valve plate that will inhibit seizing of the valve plate that overcomes these issues.

### SUMMARY OF THE INVENTION

The present invention provides a valve assembly including a valve housing with a bore having a diameter and a longitudinal axis and a reference axis perpendicular to the longitudinal axis, the bore further including an inlet for receiving a fluid and an outlet for delivering the fluid. The valve assembly also includes a rotatable valve shaft coupled to the valve housing, a valve plate located within the bore and attached to and rotatable with the rotatable shaft for rotation between a valve open position and a valve closed position, wherein, when the valve plate is in the valve closed position, the valve plate is at an angle of one of greater than and less than zero degrees relative to the reference axis. The valve plate includes a first surface facing the inlet, a second surface facing the outlet, a first circumferential surface located between the first surface and the second surface and formed to fit the diameter of the bore and confront a surface of the bore when the valve plate is in the valve closed position, and a second circumferential surface extending from at least one of the first surface and the second surface in a direction toward the reference axis and terminating at the first circumferential surface. When the valve plate is in the valve closed position, the second circumferential surface defines a gap between the surface of the bore for avoiding contact with the surface of the bore, the gap having a dimension that decreases in a direction from either one of the first surface and the second surface towards the reference axis. The first circumferential surface and the second circumferential surface define a surface spaced between the first surface and the second surface to make contact with the surface of the bore that inhibits seizing of the valve plate with the surface of the bore when the valve plate is rotated by the rotatable shaft in a valve opening direction.

One advantage of the present invention is that a new valve assembly having a valve plate provided with an anti-seize feature. Another advantage of the present invention is that the valve assembly has a valve plate with a leading edge at a relatively small angle to minimize any wedging effect and inhibit seizing of the valve plate. Yet another advantage of the present invention is that the valve assembly has a valve plate with a leading edge at an angle that has negligible impact on closed plate leakage of the valve plate. Still another advantage of the present invention is that the valve plate has a valve plate with a leading edge at an angle that is easier to manufacture. A further advantage of the present invention is that the valve assembly has a valve plate with a leading edge that is unlikely to cause sticking of the valve plate in a bore of the valve assembly.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a perspective view of one embodiment of a valve assembly for a vehicle.

FIG. 2 is an elevational view of the valve assembly of FIG. 1.

FIG. 3 is a sectional view taken along line 3-3 of FIG. 2.

FIG. 4 is an enlarged view of a portion in circle 4 of FIG. 3.

FIG. 5 is an enlarged view of a portion in circle 5 of FIG. 3.

FIG. 6 is an elevational view of a valve plate and shaft of the valve assembly of FIG. 3.

FIG. 7 is a perspective view of the valve plate of FIG. 6.

FIG. 8 is an elevational view of the valve plate of FIG. 7.

FIG. 9 is a sectional view taken along line 9-9 of FIG. 8.

FIG. 10 is a perspective view of one embodiment of a valve assembly, according to the present invention, for a vehicle.

FIG. 11 is an elevational view of the valve assembly of FIG. 10.

FIG. 12 is a sectional view taken along line 12-12 of FIG. 11.

FIG. 13 is an enlarged view of a portion in circle 13 of FIG. 12.

FIG. 14 is an enlarged view of a portion in circle 14 of FIG. 12.

FIG. 15 is an elevational view of a valve plate and shaft of the valve assembly of FIG. 12.

FIG. 16 is a perspective view of the valve plate of FIG. 15.

FIG. 17 is an elevational view of the valve plate of FIG. 16.

FIG. 18 is a sectional view taken along line 18-18 of FIG. 17.

FIG. 19 is an enlarged view of a portion in circle 13 of FIG. 12, according to another embodiment of the present invention.

FIG. 20 is an enlarged view of a portion in circle 14 of FIG. 12, according to another embodiment of the present invention.

FIG. 21 is an enlarged view of a portion in circle 13 of FIG. 12, according to yet another embodiment of the present invention.

FIG. 22 is an enlarged view of a portion in circle 14 of FIG. 12, according to yet another embodiment of the present invention.

FIG. 23 is an enlarged view of a portion in circle 13 of FIG. 12, according to a further another embodiment of the present invention.

FIG. 24 is an enlarged view of a portion in circle 14 of FIG. 12, according to a further another embodiment of the present invention.

### DETAILED DESCRIPTION OF THE INVENTION

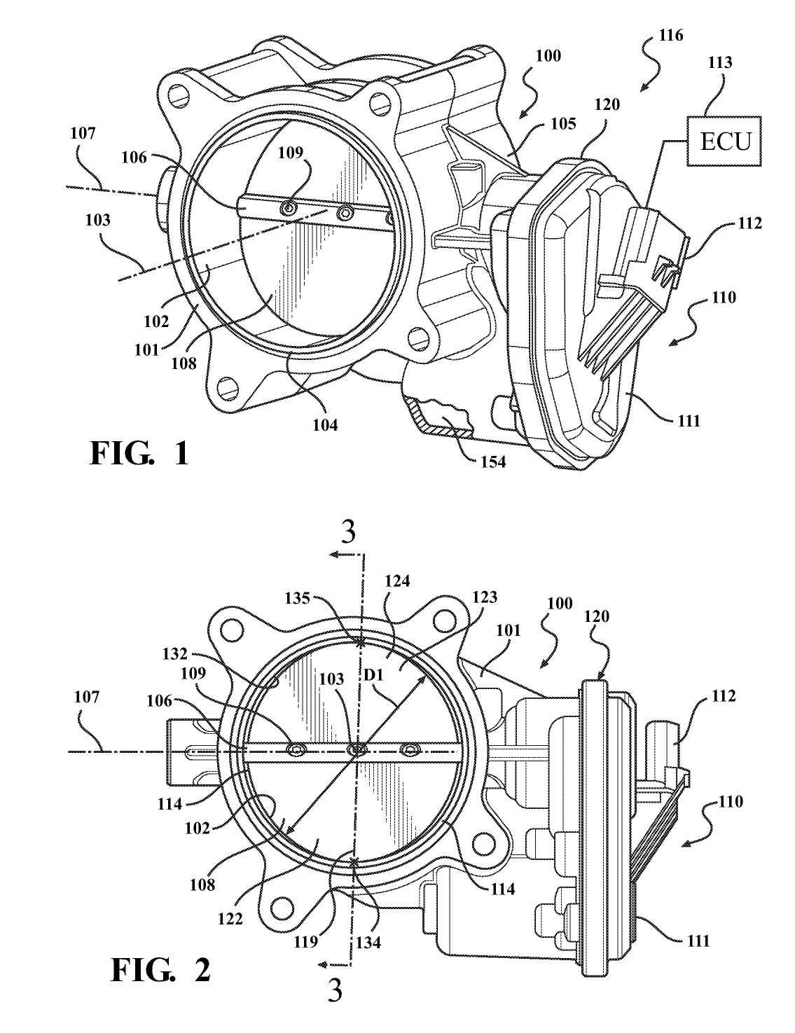

Referring now to the figures, wherein like numerals are used to designate like structure unless otherwise indicated, one embodiment of a valve assembly 100 is shown in FIGS. 1 and 2 for a vehicle (not shown). As illustrated in FIGS. 1-3, the valve assembly 100 may include a housing 101 having a bore 102 with a diameter D1 and a longitudinal axis 103. The bore 102 may have an inlet 104 for receiving air and an outlet 105 for delivering the air. In one embodiment, the inlet 104 and outlet 105 are spaced along the longitudinal axis 103. The valve assembly 100 also includes a rotatable shaft 106 that may pass through the bore 102 and may be supported by the housing 101 for rotation about a transverse axis 107 which may be generally perpendicular to the longitudinal axis 103 of the bore 102. A reference axis 119 may be perpendicular to both the longitudinal axis 103 of the bore 102 and the transverse axis 107 of the rotatable shaft 106. It should be appreciated that the reference axis 119 may also intersect both the longitudinal axis 103 and the transverse axis 107.

The valve assembly 100 includes a valve plate 108 that may be attached to the rotatable shaft 106 by a suitable mechanism such as screws 109, rivets, pins, or welding. The valve plate 108 is disposed or located within the bore 102 and may rotate with the rotatable shaft 106 to control the opening and closing of the valve plate 108 and the flow of air between the inlet 104 and the outlet 105 of the valve assembly 100.

The valve assembly 100 may also include an actuator 110 that may be used to rotate and position the rotatable shaft 106 and the valve plate 108. The actuator 110 may be one of a variety that may include pneumatic, hydraulic, or electric and may be integrated within the housing 101 or may be a separate housing attached to the housing 101. The actuator 110 may include an electrical drive device 154 for providing a rotational force in response to being powered by an electrical control signal applied to the actuator 110. The electrical drive device 154 may be a brush direct current (D.C.) motor, brushless D.C. motor, stepper motor, a torque motor, an alternating current (A.C.) motor, or another type of electrical drive device. The actuator 110 may also include a gear drive system (not shown) for increasing the rotational force provided by the electrical drive device 154. The rotatable shaft 106 may be coupled to actuator 110 and the rotational force provided by the electrical drive device 154 of the actuator 110 may be translated to the rotatable shaft 106 to move and position the rotatable shaft 106 and the valve plate 108.

The valve assembly 100 may include a cover 111 that may enclose the actuator 110 within the housing 101 and may be secured to the housing 101 by a suitable mechanism such as a clinch ring 120. The cover 111 may also include an electrical connector 112 and electrical connections (not shown) to provide the electrical control signal to the actuator 110. It should be appreciated that an electrical control signal having a first polarity may cause the actuator 110 to rotate the rotatable shaft 106 and the valve plate 108 in a valve opening direction 117 that may allow air flow between the inlet 104 and the outlet 105, and an electrical control signal having a second polarity may cause the actuator 110 to rotate the rotatable shaft 106 and the valve plate 108 in a valve closing direction 118 that may block or minimize air flow between the inlet 104 and the outlet 105.

The valve assembly 100 may be used in a system 116 of the vehicle to control the flow of a fluid such as air or exhaust gas as previously described herein. As illustrated in FIG. 1, the system 116 may include an electronic control unit (ECU) 113 for controlling the actuator 110 of the valve assembly 100. In one embodiment, the ECU 113 may be a vehicle controller. It should be appreciated that, as illustrated, the ECU 113 may be a separate component or an ECU integrated within the actuator 110 and receive a command signal from another controller.

In operation of the system 116, the ECU 113 may provide an electrical position input signal indicating a desired position of the actuator 110, rotatable shaft 106, and valve plate 108. The desired position may also be referred to as a commanded positon of the actuator 110. The ECU 113 may provide the necessary electrical control signal to move the actuator 110. The actuator 110 may move the rotatable shaft 106 and the valve plate 108 to a position that may achieve a desired fluid flow. The actuator 110 may also have a mechanism to sense its position and may provide feedback of an electrical position output signal to the ECU 113. It should be appreciated that a “closed loop” control scheme may be used to maintain a commanded actuator position of the actuator 110 by comparing value of the electrical position output signal to a commanded value and may adjust the electrical control signal to the actuator 110 to maintain the position of the rotatable shaft 106 and the valve plate 108 and the desired fluid flow.

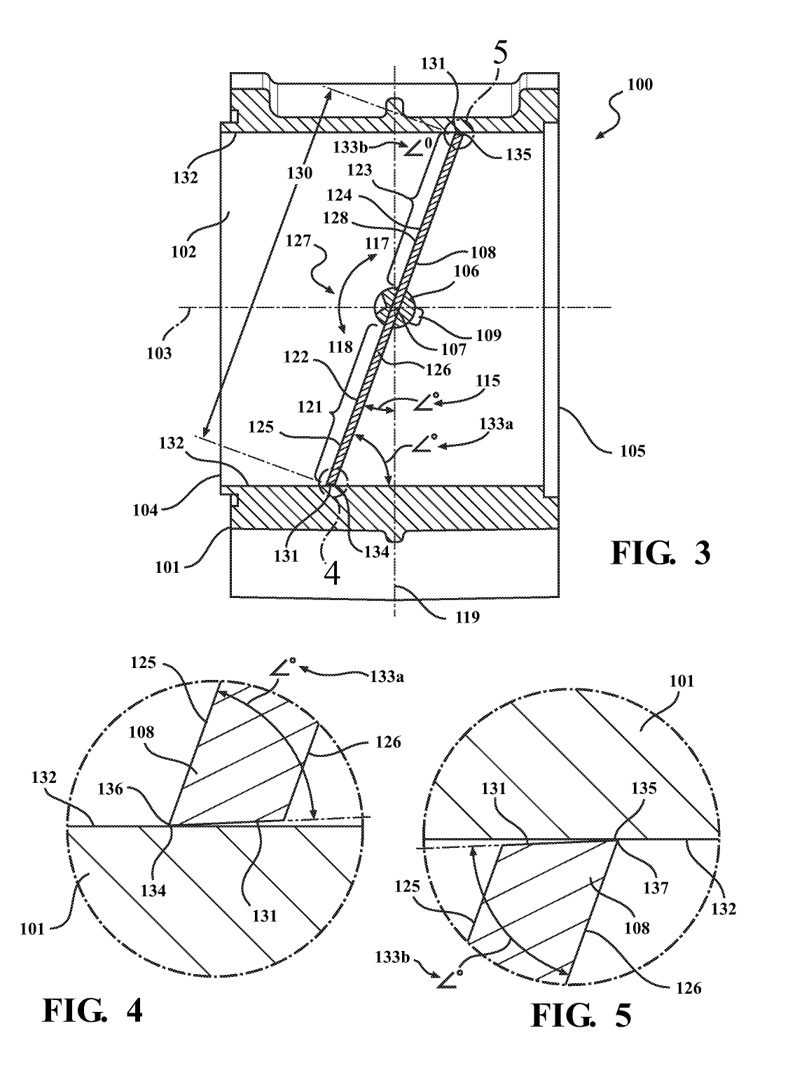

In order to ensure movement of the valve plate 108 within the bore 102, it may be necessary to have sufficient radial clearance 114 between the valve plate 108 and the bore 102, to allow for manufacturing tolerances, thermal expansion, or other factors that may influence the dimension of the bore 102 and the valve plate 108. As illustrated in FIG. 3, it may also be necessary to place the valve plate 108 at an angle 115 relative to the reference axis 119 when the valve plate 108 is in the valve closed position. Placing the valve plate 108 on an angle 115 may prevent the valve plate 108 from being seized within the bore 102 during thermal expansion and contraction. In the embodiment illustrated in FIG. 3, the angle 115 is approximately twenty (20) degrees. Depending upon the operating temperature range, the angle 115 may be within a range of 5 degrees to 45 degrees, however angles less than 5 degrees and greater than 45 degrees may also be considered. It should be appreciated that the angle 115 may be a negative angle if the valve plate 108 was repositioned (by rotating the valve plate 108 counterclockwise beyond the reference axis 119) to accommodate a different open/close rotation.

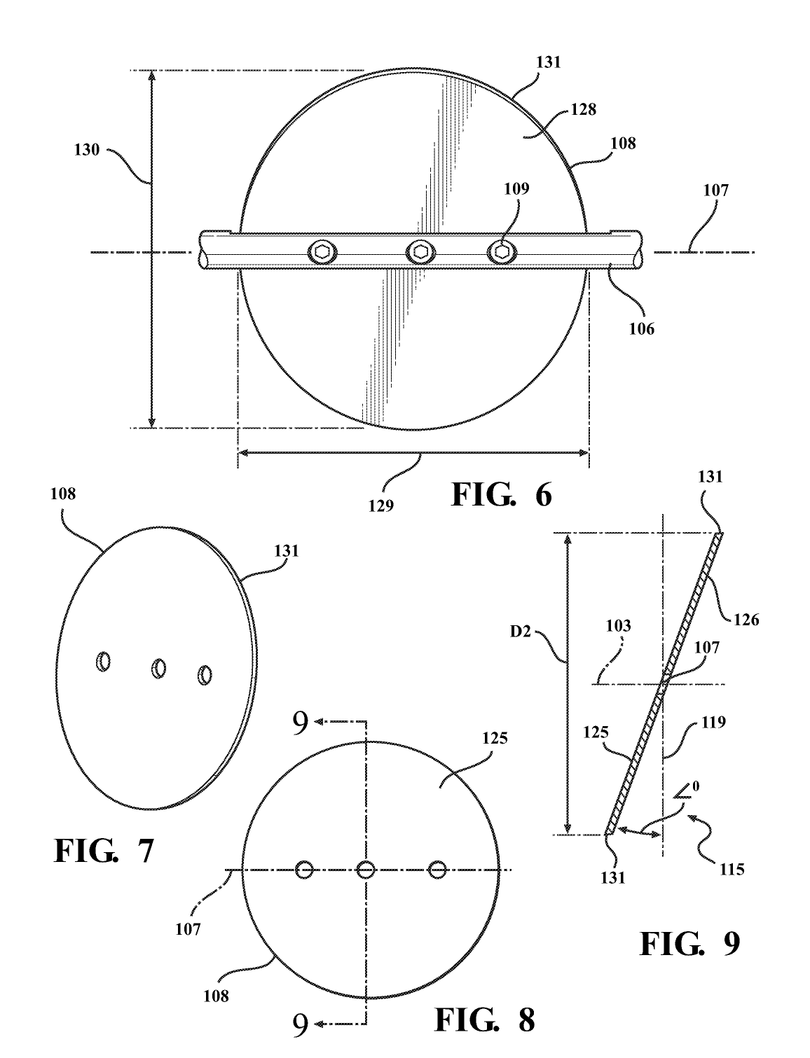

Since the valve plate 108 is at the angle 115 relative to the reference axis 119, the valve plate 108 may have an oval shape when viewed in a direction of arrow 127 that is generally perpendicular to a flat surface 128 of the valve plate 108 as seen in FIGS. 3-6. The valve plate 108 has a width 129 measured along the transverse axis 107 of the rotatable shaft 106 that will be less than its length 130 which is measured perpendicular to the transverse axis 107 of the rotatable shaft 106.

FIGS. 7-9 show views of only the valve plate 108. To fit the oval shaped valve plate 108 to the bore 102, the valve plate 108 must be made with a diameter D2 that is less than the diameter D1 of the bore 102. When the valve plate 108 is placed on the angle 115 and then viewed from the front, as shown in FIGS. 7-9, it will appear as a circle having the diameter D2 which may be less than the diameter D1 by an amount that may be approximately equivalent to two times a desired radial clearance 114 (FIG. 2). In one embodiment, a clearance of 0.100 millimeter may be suitable for some applications, however, a clearance less than 0.100 millimeter or greater than 0.100 millimeter may be considered. The desired radial clearance 114 may be determined by a number of factors such as manufacturing tolerances, material selection for the valve plate 108 and the valve housing 101, thermal coefficient of expansion for the component materials, operating temperature, or other factors. The valve plate 108 may be made using processes such as stamping, machining, casting, electric discharge machining (EDM), or other suitable processes.

As illustrated in FIG. 3, the valve plate 108 has a first portion 121 located on a first side 122 of the rotatable shaft 106 and a second portion 123 located on a second side 124 of the rotatable shaft 106. For valve applications requiring a pressure balanced valve plate 108, the first and second portions 121, 123 may have similar geometries and areas. However, some applications may intentionally have different geometries and areas to bias the force, caused by pressure acting on the valve plate 108, in either the valve closing direction 118 or the valve opening direction 117.

Referring to FIGS. 3-6, the valve plate 108 may have a first surface 125 that generally faces the inlet 104 and a second surface 126 that generally faces the outlet 105. The valve plate 108 may also have a circumferential surface 131 spanning between the first and second surfaces 125, 126 that may be in close proximity to a surface 132 of the bore 102 when the valve plate 108 is in the valve closed position. As previously mentioned, the valve plate 108 may be at the angle 115 relative to the reference axis 119 and, therefore, the circumferential surface 131 must be made with an acute angle 133a and 133b relative to the surfaces 125, 126 of the valve plate 108. The acute angles 133a, 133b may be the complementary to the angle 115, and, may ensure close proximity of the circumferential surface 131 of the valve plate 108 to the surface 132 of the bore 102 to block or minimize fluid flow past the valve plate 108 as shown in FIG. 3. It should be appreciated that the acute angles 133a, 133b may not be constant and may vary around the circumference of the valve plate 108 in order to provide a suitable fit and the desired radial clearance 114 with the bore 102.

When the valve plate 108 is mounted to the rotatable shaft 106 and fit to the bore 102, the valve plate 108 may make limited contact with the bore 102. The contact of the valve plate 108 with the bore 102 will typically occur on its circumferential surface 131, at contact points 134 and 135 near its distal ends along its length 130 as shown in FIG. 2 and FIG. 3. It should be appreciated that the fit provided by the angle 115 and the desired radial clearance 114 may provide suitable performance and sealing of the valve plate 108, however, it may also locally concentrate the closing force at the contact points 134, 135 due in part to the acute angles 133a, 133b and the desired radial clearance 114.

Referring to FIGS. 2-5, when the rotatable shaft 106 and the valve plate 108 are forcibly rotated in the valve closing direction 118, a surface or edge 136, formed by the acute angle 133a where the first surface 125 intersects the circumferential surface 131 of the valve plate 108, may make contact with the surface 132 of the bore 102 in proximity to the contact point 134, and, the force applied to the contact area may cause seizing of the valve plate 108 in the bore 102 of the valve housing 101 when a rotational force is applied to the rotatable shaft 106 in the valve opening direction 117. In a similar manner, when the rotatable shaft 106 and the valve plate 108 are forcibly rotated in the valve closing direction 118, a surface or edge 137, formed by the acute angle 133b where the second surface 126 intersects the circumferential surface 131 of the valve plate 108, may make contact with the surface 132 of the bore 102 in proximity to the contact point 135, and, the force applied to the contact area may cause seizing of the valve plate 108 in the bore 102 of the valve housing 101 when a rotational force is applied to the rotatable shaft 106 in the valve opening direction 117. It should be appreciated that the seizing that may result from contact between the surface or edge 136, 137 of the valve plate 108 and the surface 132 of the bore 102 may be caused by friction, scrapping, gouging, or other condition.

The potential for seizing may be increased under certain conditions. A first condition may occur when there is a build-up of residue or debris on the surface 132 of the bore 102 that may be deposited from a fluid such as exhaust gas or air flowing through the bore 102. A second condition may occur when a high closing force is applied by the actuator 110 or if there is a high external force, such as high fluid pressure, applied to the valve plate 108. Under extreme conditions, the valve plate 108 may flex and may increase the potential for seizing. It is therefore desirable to develop a valve plate that will inhibit the seizing condition.

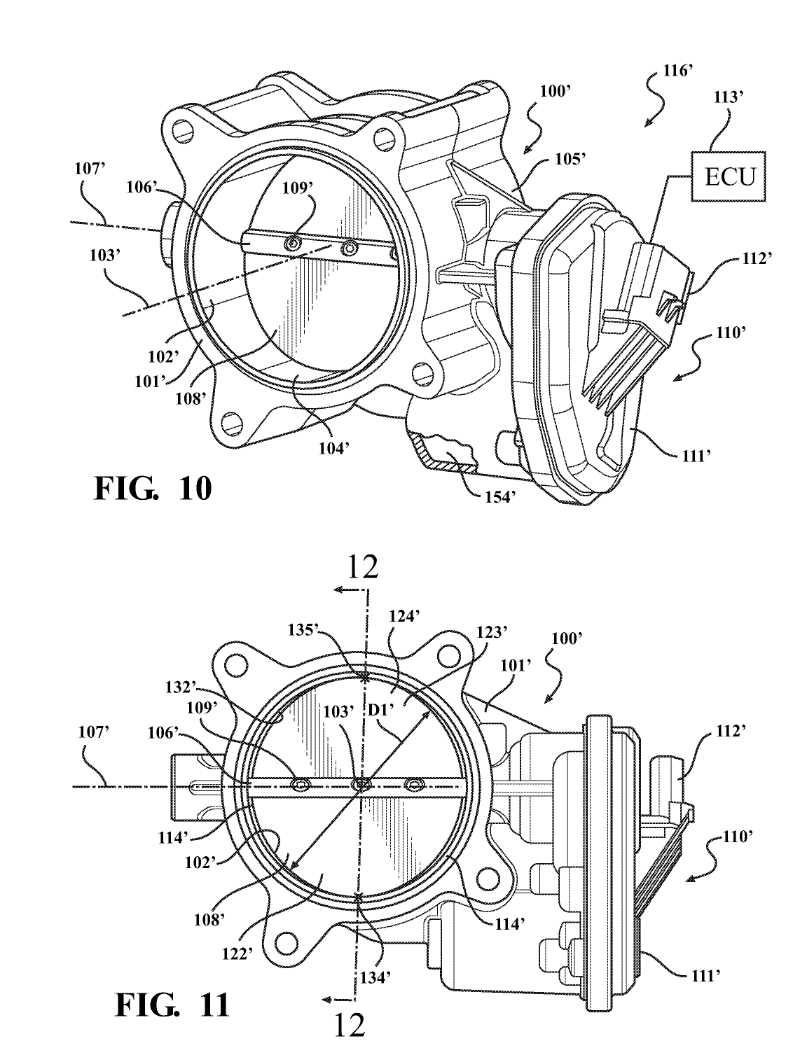

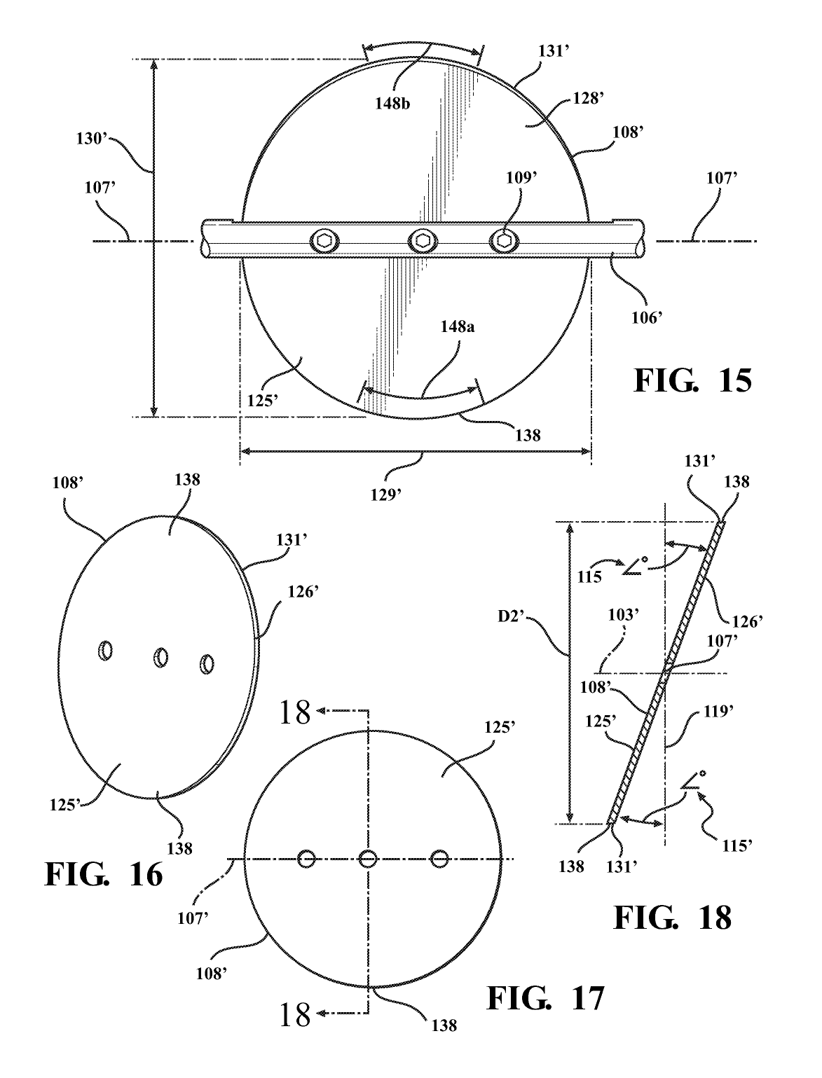

Referring to FIGS. 10-18, a first embodiment, according to the present invention, of the valve assembly 100 is shown. Like parts of the valve assembly 100 have like reference numerals increased by an apostrophe. In this embodiment, the valve assembly 100′ may include an actuator 110′ and be used in a system 116′. The actuator 110′ may include an electrical drive device 154′ similar to the electrical drive device 154 of the actuator 110. The electrical drive device 154′ may provide a rotational force in response to being powered by an electrical control signal applied to the actuator 110′. The actuator 110′ and system 116′ have a design, operation, and function similar to the actuator 110 and system 116 previously described herein and will therefore not be restated, however, it is to be understood that the design, operation, and function of the actuators 110, 110′ and systems 116, 116′ may be directly applied to the present invention and the valve assembly 100′ to be described in greater detail.

Referring to FIGS. 10-12, the valve assembly 100′ includes a housing 101′ having a bore 102′ with a diameter D1′ and a longitudinal axis 103′. The bore 102′ has an inlet 104′ for receiving air and an outlet 105′ for delivering the air. The valve assembly 100′ includes a rotatable shaft 106′ that may pass through the bore 102′ and be supported by the housing 101′ for rotation about a transverse axis 107′ which is generally perpendicular to the longitudinal axis 103′ of the bore 102′. A reference axis 119′ is perpendicular to both the longitudinal axis 103′ of the bore 102′ and the transverse axis 107′ of the rotatable shaft 106′. It should be appreciated that the reference axis 119′ may also intersect both the longitudinal axis 103′ and the transverse axis 107′.

The valve assembly 100′ also includes a valve plate 108′ that may be attached to the rotatable shaft 106′ by a suitable mechanism such as screws 109′, rivets, pins, or welding. The valve plate 108′ is disposed or located within the bore 102′ and may rotate with the rotatable shaft 106′ to control the opening and closing of the valve plate 108′ and the flow of fluid between the inlet 104′ and the outlet 105′ of the valve assembly 100′.

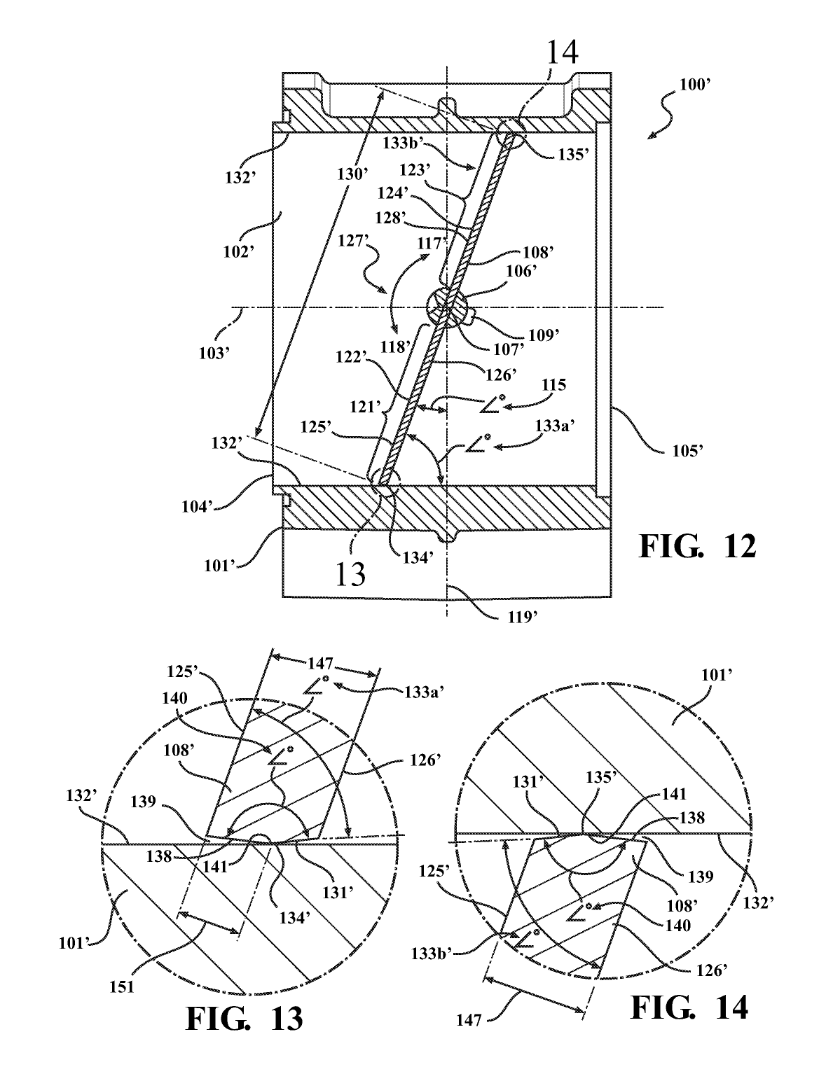

The valve plate 108′ is similar to the valve plate 108 and, therefore to ensure movement of the valve plate 108′ within the bore 102′, it may be necessary to have sufficient radial clearance 114′ between the valve plate 108′ and the bore 102′ to allow for manufacturing tolerances, thermal expansion, or other factors that may influence the dimension of the bore 102′ and the valve plate 108′. As illustrated in FIGS. 12-14, it may also be necessary to place the valve plate 108′ at an angle 115′ relative to the reference axis 119′ when the valve plate 108′ is in the valve closed position. The angle 115′ may be within a range of 5 degrees to 45 degrees, however angles less than 5 degrees and greater than 45 degrees may also be considered. It should be appreciated that the angle 115′ may be a negative angle if the valve plate 108′ was repositioned (by rotating the valve plate 108′ counterclockwise beyond the reference axis 119′) to accommodate a different open/close rotation.

Since the valve plate 108′ is at the angle 115′ relative to the reference axis 119′, the valve plate 108′ may have an oval shape when viewed in a direction of arrow 127′ that is generally perpendicular to a flat surface 128′ of the valve plate 108′ as shown in FIGS. 12-14. The valve plate 108′ has a width 129′ measured along the transverse axis 107′ of the rotatable shaft 106′ that will be less than its length 130′ measured perpendicular to the transverse axis 107′ of the rotatable shaft 106′.

FIGS. 16-18 show views of only the valve plate 108′. To fit the oval shaped valve plate 108′ to the circular bore 102′, the valve plate 108′ must be made with a diameter D2′ that is less than the diameter D1′ of the bore 102′. When the valve plate 108′ is placed on the angle 115′ and then viewed from the front, as shown in FIG. 16, the valve plate 108′ will appear as a circle having the diameter D2′ which may be less than the diameter D1′ by an amount that may be approximately equivalent to two times a desired radial clearance 114′. In one embodiment, a clearance of 0.100 millimeter may be suitable for some applications, however, a clearance less than 0.100 millimeter or greater than 0.100 millimeter may be considered. The desired radial clearance 114′ may be determined by a number of factors such as manufacturing tolerances, material selection for the valve plate 108′ and the valve housing 101′, thermal coefficient of expansion for the component materials, operating temperature, or other factors. The valve plate 108′ may be made using processes such as stamping, machining, casting, electric discharge machining (EDM), or other suitable process.

As illustrated in FIGS. 12-14, the valve plate 108′ has a first portion 121′ located on a first side 122′ of the rotatable shaft 106′ and a second portion 123′ located on a second side 124′ of the rotatable shaft 106′. For valve applications requiring a pressure balanced valve plate 108′, the first and second portions 121′, 123′ may have similar geometries and areas. However, some applications may intentionally have different geometries and areas to bias the force, caused by pressure acting on the valve plate 108′, in either the valve closing direction 118′ or the valve opening direction 117′.

Referring to FIGS. 12-18, the valve plate 108′ may have a first surface 125′ that generally faces the inlet 104′ and a second surface 126′ that generally faces the outlet 105′. The valve plate 108′ may have a first circumferential surface 131′ spanning at least partially between the first and second surfaces 125′, 126′ that may be in close proximity to a surface 132′ of the bore 102′ when the valve plate 108′ is in the valve closed position. As previously mentioned, the valve plate 108′ may be at an angle 115′ relative to the reference axis 119′ and, therefore, the first circumferential surface 131′ must be made with an angle 133a′ and 133b′ relative to the first and second surfaces 125′, 126′ of the valve plate 108′. The angles 133a′, 133b′ may be the complementary to the angle 115′, and, may ensure close proximity of the first circumferential surface 131′ of the valve plate 108′ to the surface 132′ of the bore 102′ to block or minimize fluid flow past the valve plate 108′ as shown in FIGS. 12-14. It should be appreciated that the angles 133a′, 133b′ may not be constant and may vary around the circumference of the valve plate 108′ in order to provide a suitable fit and the desired radial clearance 114′ with the bore 102′.

Referring to FIGS. 13 and 14, a second circumferential surface 138 may extend from the first and/or second surface 125′, 126′ in a direction moving toward the reference axis 119′ and terminates at the first circumferential surface 131′. When the valve plate 108′ is in the valve closed position, the second circumferential surface 138 defines a gap 139 between itself and the bore 132′ for preventing contact between an edge or surface of first and/or second surface 125′, 126′ with the bore 132′ which may otherwise encourage seizing. The gap 139 reduces in dimension in a direction moving from the first and/or surface 125′, 126′ towards the reference axis 119′. As illustrated in FIG. 12, the second circumferential surface 138 is formed at an angle 140 relative to the first circumferential surface 131′ and defines a surface 141 to make contact with the bore 102′ when the rotatable shaft 106′ rotates the valve plate 108′ to the valve closed position. The contact of the surface 141 with the bore 102′ will typically occur at or near point 134′ and 135′ near the distal ends of the valve plate 108′ as shown in FIGS. 11 and 12. It should be appreciated that the angle 140 of 174 degrees to 177 degrees has been shown to provide a more desirable contact surface that is effective for inhibiting seizing of the valve plate 108′, however, angles of less than 174 degrees and greater than 177 degrees may be considered.

The addition of the second circumferential surface 138 has enabled the anti-seizing feature which includes the gap 139 and the surface 141. When the rotatable shaft 106′ rotates the valve plate 108′ to the valve closed position, the second circumferential surface 138 will provide the gap 139 to avoid the contact previously made by the surfaces or edges 136,137 of the valve plate 108 within the bore 102 of the valve assembly 100 which may cause seizing of the valve plate 108 in the bore 102. The second circumferential surface 138 and first circumferential surface 131′ also define the surface 141 that will make more desirable contact with the bore 102′ and inhibit seizing of the valve plate 108′ which had been experienced when the surfaces or edges 136,137 of the valve plate 108 made contact within the bore 102 of the valve assembly 100.

As previously stated herein, the feature of the valve plate 108′ preventing seizing may have several forms or embodiments. It is also within the scope of the present invention to use another shape on the circumferential surface of the valve plate 108′. It should be appreciated that, for example, a curved shape, a rounded shape, a series of flat shapes, and a combination thereof may be used.

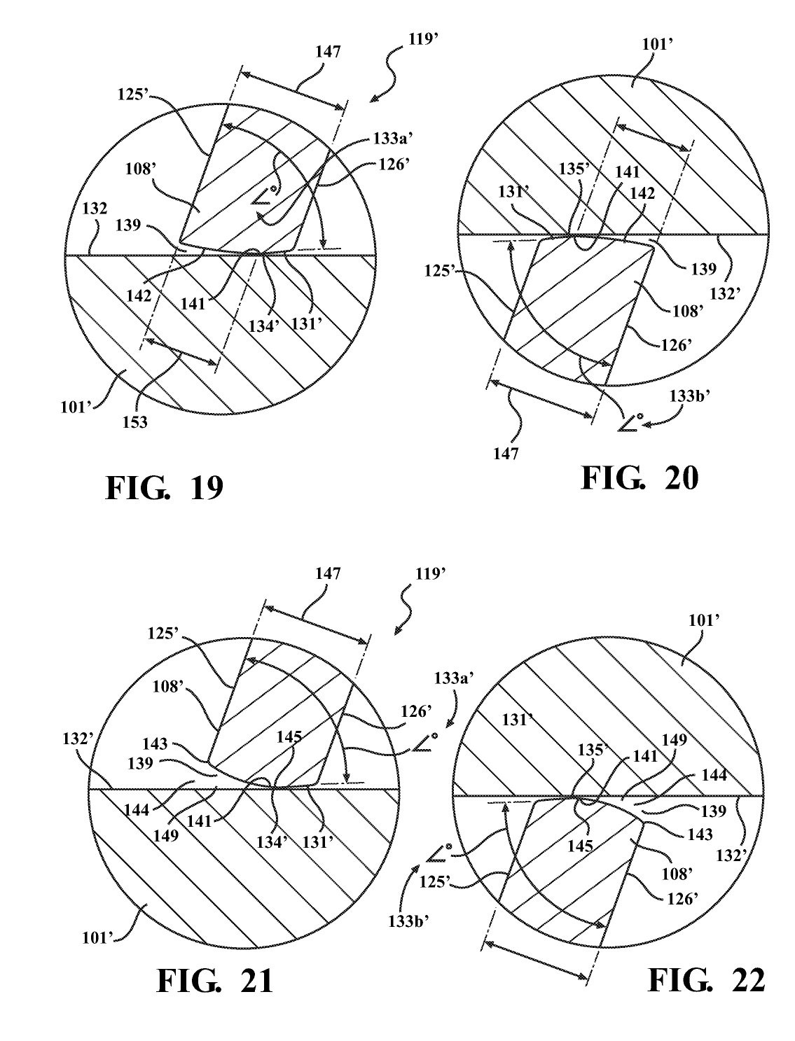

FIGS. 19-24 are views of additional embodiments similar to the enlarged views illustrated in FIGS. 13 and 14. Each figure shows additional embodiments or shapes for inhibiting seizing and each figure shows the valve plate 108′ in the valve closed position. Like parts of the valve assembly 100′ have like reference numerals.

Referring to FIGS. 19 and 20, a second embodiment, according to the present invention, of the valve plate 108′ is shown. In this embodiment, the valve plate 108′ includes the first surface 125′, the second surface 126′, and the first circumferential surface 131′. The second circumferential surface 142 is a curved or arcuate shaped and extends from the first and second surfaces 125′, 126′ and terminates at the first circumferential surface 131′. The second circumferential surface 142 provides the gap 139 to avoid the contact with the bore 102′. The second circumferential surface 142 also terminates at the first circumferential surface 131′ and provides a surface 141 that makes contact with the surface 132′ of the bore 102′ and inhibits seizing of the valve plate 108′ in the bore 102′ as previously described herein.

Referring to FIGS. 21 and 22, a third embodiment, according to the present invention, of the valve plate 108′ is shown. In this embodiment, the valve plate 108′ includes the first surface 125′, the second surface 126′, and the first circumferential surface 131′. The second circumferential surface 149 includes a partially round or arcuate surface 143 extending from the first or second surfaces 125′, 126′ and a straight or linear surface 144, connected to the partially arcuate surface 143. The linear surface 144 is connected to the first circumferential surface 131′ by a radius surface 145 which forms a portion of both the first circumferential surface 131′ and the second circumferential surface 149. The second circumferential surface 149 includes the combination of the partially arcuate surface 143, linear surface 144, and a portion of the radius surface 145 that provides the gap 139 to avoid the contact with the bore 102′. The second circumferential surface 149 also terminates at the first circumferential surface 131′ along the shared radius surface 145 and provides a surface 141′ that makes contact with the surface 132′ of the bore 102′ and inhibits seizing of the valve plate 108′ in the bore 102′ as previously described herein.

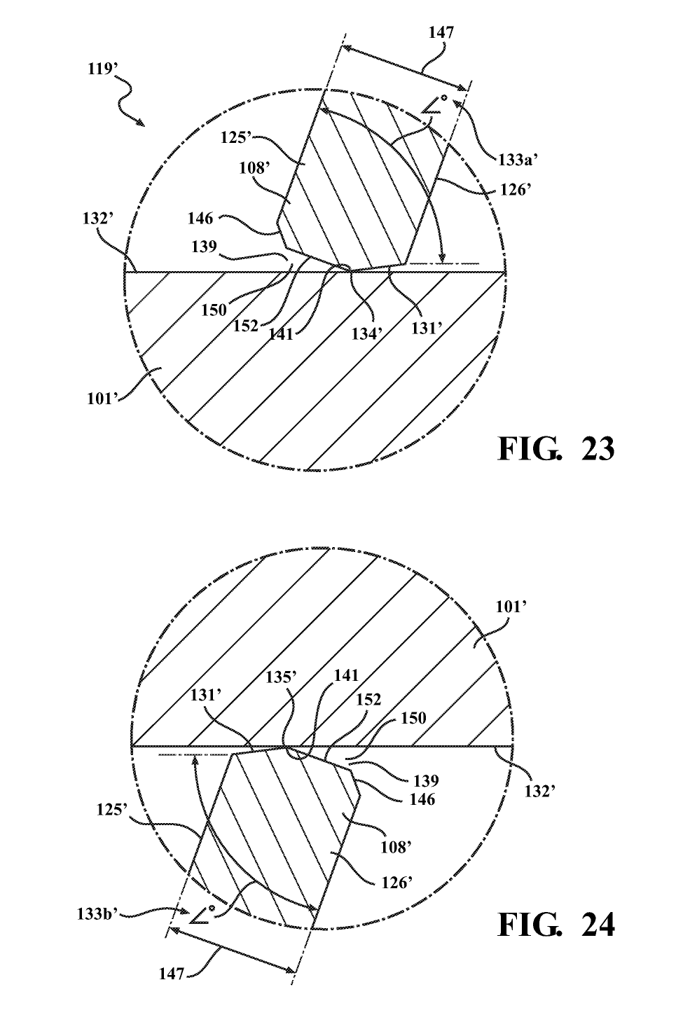

Referring to FIGS. 23 and 24, a fourth embodiment, according to the present invention, of the valve plate 108′ is shown. In this embodiment, the valve plate 108′ includes the first surface 125′, the second surface 126′, and the first circumferential surface 131′. The second circumferential surface 150 is a combination of a first straight or linear surface 146 extending from the first and second surfaces 125′, 126′ and a second straight or linear surface 152, connected to the first linear surface 146, and terminating at the first circumferential surface 131′. The second circumferential surface 150 includes a first straight or linear surface 146 and a second straight or linear surface 152 that provides the gap 139 to avoid contact with the bore 102′. The second circumferential surface 150 also terminates at the first circumferential surface 131′ and provides a surface 141 that makes contact with the surface 132′ of the bore 102′ and inhibits seizing of the valve plate 108′ in the bore 102′ as previously described herein.

As illustrated in FIGS. 13 and 14, the surface 141 was located at a dimension 151 that may be approximately half of the total thickness 147, defined by the first surface 125′ and second surface 126′ of the valve plate 108′. It is also possible to have the surface 141 located at a dimension that is greater or less than half the total thickness 147 of the valve plate 108′. For example, FIGS. 19 and 20 shows the surface 141 located at a dimension 153 that is approximately two-thirds of the total thickness 147 of the valve plate 108′ measured from the first surface 125′. It should be appreciated that the selected dimension or location of the surface 141 may depend upon factors that include, but are not limited to, the thickness of the valve plate 108′, the diameter of the valve plate 108′, the shape of the circumferential surfaces, the material of the valve plate 108′, the manufacturing process, the durability, and reliability.

The span of the second circumferential surface 138 and the surface 141 along the first circumferential surface 131 may also vary. As illustrated in FIGS. 11-18, the span 148a and 148b is approximately 25% of the total circumference of the valve plate 108′. The valve plate 108′ includes the span 148a of the second circumferential surface 138 and the surface 141 extending from first surface 125′ and the span 148b of the second circumferential surface 138 and the surface 141 extending from the second surface 126′. Since contact between the valve plate 108′ and the bore 102′ occurs over a limited area, typically at the contact points 134′, 135′, it may only be necessary to have a small span for some applications that is less than 25%. It should be appreciated that, within the scope of the present invention, the second circumferential surface 138 and the surface 141 may have a span that is greater 25%. The selection of the span may depend upon factors that include, but are not limited to, the width of the valve plate 108′, the diameter of the valve plate 108′, the material of the valve plate 108′, the manufacturing process, the durability, and reliability.

For the embodiment of FIGS. 12-18, the second circumferential surface 138 and the surface 141 extend from both the first and second surfaces 125′, 126′ of the valve plate 108′. It should be appreciated that, within the scope of the present invention, the second circumferential surface 138 and the surface 141 may extend from only one of the first surface 125′ or the second surface 126′. It should also be appreciated that the decision to have the second circumferential surface 138 and the surface 141 extend from one or both of the first and second surfaces 125′, 126′ may depend on factors that include, but are not limited to, the diameter of the valve plate 108′, the fit of the valve plate 108′ to the bore 102′, manufacturing and positional tolerances, the manufacturing process, the desired leakage of fluid past the valve plate 108′, the durability, and reliability.

Accordingly, the valve assembly 100′ of the present invention includes a valve plate 108′ with a circumferential surface that is shaped to minimize seizing within the bore 102′ of the valve assembly 100′. The valve plate 108′ of the present invention has a leading edge at an angle to minimize any wedging effect and has negligible impact on closed plate leakage. The valve plate 108′ of the present invention has the leading edge at an angle that is easier to manufacture.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

What is claimed is:

1. A valve assembly comprising:
a valve housing including a bore having a diameter and a longitudinal axis and a reference axis perpendicular to the longitudinal axis, the bore further including an inlet for receiving a fluid and an outlet for delivering;
a rotatable valve shaft coupled to the valve housing;
a valve plate located within the bore and attached to and rotatable with the rotatable shaft for rotation between a valve open position and a valve closed position, wherein, when the valve plate is in the valve closed position, the valve plate is at an angle of one of greater than and less than zero degrees relative to the reference axis;
the valve plate comprising a first surface facing the inlet, a second surface facing the outlet, a first circumferential surface located between the first surface and the second surface and formed to fit the diameter of the bore and confront a surface of the bore when the valve plate is in the valve closed position, and a second circumferential surface extending from at least one of the first surface and the second surface in a direction toward the reference axis and terminating at the first circumferential surface and having a taper and the taper having an angle between 174 degree and 177 degrees relative to the first circumferential surface;
wherein when the valve plate is in the valve closed position, the second circumferential surface defines a gap between the surface of the bore for avoiding contact with the surface of the bore, the gap having a dimension that decreases in a direction from either one of the first surface and the second surface towards the reference axis; and
wherein the first circumferential surface and the second circumferential surface define a surface spaced between the first surface and the second surface to make contact with the surface of the bore that inhibits seizing of the valve plate with the surface of the bore when the valve plate is rotated by the rotatable shaft in a valve opening direction.

2. A valve assembly as set forth in claim 1 wherein the second circumferential surface has a taper and the taper has an angle between 174 degree and 177 degrees relative to the first circumferential surface.

3. A valve assembly as set forth in claim 1 wherein the second circumferential surface has a taper and the taper has an angle one of less than 174 degrees and greater than 177 degrees relative to the first circumferential surface.

4. A valve assembly as set forth in claim 1 wherein the second circumferential surface forms one of a partially circular surface, an arcuate surface, a linear surface, and a combination thereof.

5. A valve assembly as set forth in claim 1 wherein, when the valve plate is in the valve closed position, the angle between at least one of the first surface and the second surface and the reference axis is between 5 degrees and 45 degrees.

6. A valve assembly as set forth in claim 1 wherein, when the valve plate is in the valve closed position, the angle between at least one of the first surface and the second surface and the reference axis is between −5 degrees and −45 degrees.

7. A valve assembly as set forth in claim 1 wherein, when the valve plate is in the valve closed position, the angle between at least one of the first surface and the second surface and the reference axis is one of less than 5 degrees and greater than 45 degrees.

8. A valve assembly as set forth in claim 1 wherein, when the valve plate is in the valve closed position, the angle between at least one of the first surface and the second surface and the longitudinal axis is one of less than −5 degrees and greater than −45 degrees.

9. A valve assembly as set forth in claim 1 wherein the second circumferential surface is located on a portion of a total circumference of the valve plate and is one of less than and equal to 25 percent of the total circumference.

10. A valve assembly as set forth in claim 1 wherein the second circumferential surface is located on a portion of a total circumference of the valve plate and is greater than 25 percent of the total circumference.

11. A valve assembly as set forth in claim 1 wherein the second circumferential surface extends from only one of the first surface and the second surface of the valve plate.

12. A valve assembly as set forth in claim 1 wherein the second circumferential surface extends from both of the first surface and the second surface of the valve plate.

13. A valve assembly as set forth in claim 1 wherein the first surface and the second surface further define a total thickness of the valve plate and the surface to make contact with the surface of the bore is located at a dimension, measured from one of the first surface and the second surface equal to one-half of a total thickness of the valve plate.

14. A valve assembly as set forth in claim 1 wherein the first surface and the second surface further define a total thickness of the valve plate and the surface to make contact with the surface of the bore located at a dimension measured from one of the first surface and the second surface and is one of greater than and less than one-half of a total thickness of the valve plate.

15. A valve assembly comprising:
a valve housing including a circular bore having a diameter and a longitudinal axis, the circular bore further including an inlet for receiving a fluid and an outlet for delivering the fluid;
a rotatable shaft supported in the valve housing and having a transverse axis that is generally perpendicular to the longitudinal axis of the circular bore;
a reference axis perpendicular to and intersecting both the longitudinal axis of the circular bore and the transverse axis of the rotatable shaft;
a valve plate located within the circular bore and attached to and rotatable with the rotatable shaft for rotation between a valve open position and a valve closed position, wherein, when the valve plate is in the valve closed position the valve plate is at an angle of one of greater than and less than zero degrees relative to the reference axis, and, wherein the valve plate has an oval shape to fit the circular bore and having a width;
the valve plate comprising a first surface facing the inlet, a second surface facing the outlet, a first circumferential surface located between the first surface and the second surface and formed to fit a diameter of the circular bore and confront a surface of the circular bore when the valve plate is in the valve closed position, and a second circumferential surface extending from at least one of the first surface and the second surface in a direction moving toward the reference axis and terminating at the first circumferential surface;
wherein when the valve plate is in the valve closed position, the second circumferential surface defines a gap between the circular bore for avoiding contact with the circular bore, the gap having a dimension that decreases moving in a direction from one of the first surface and the second surface towards the reference axis; and
wherein the first circumferential surface and second circumferential surface define a surface spaced between the first surface and the surface to make contact with the circular bore that will inhibit seizing of the valve plate in the circular bore when the valve plate is rotated by the rotatable shaft in a valve opening direction.
